(19) United States
(12) Patent Application Publication
(10) Pub. No.: US 2010/0100448 A1
(43) Pub. Date: Apr. 22, 2010

(54) REFERRAL SYSTEM AND METHOD

(76) Inventors: Fred Heigold, Denver, CO (US); Walter Charnoff, Denver, CO (US)

Correspondence Address: ROBERT A. PARSONS, 4000 N. CENTRAL AVENUE, SUITE 1220, PHOENIX, AZ, 85012, US

(21) Appl. No.: 12/572,213

(22) Filed: Oct. 1, 2009

Related U.S. Application Data
(60) Provisional application No. 61/102,134, filed on Oct. 2, 2008.

(51) Int. Cl. G06Q 30/00; G06Q 50/00; G06F 17/30

(52) U.S. Cl. 705/14.66; 705/14.73; 707/802; 707/E17.044

(57) ABSTRACT

A professional referral system on a website including a data base and server coupled thereto and further coupled into a publicly available website. The data base including a plurality of vertical business groups stored therein, each vertical business group including a plurality of ad-slots with each ad-slot including information relative to a member of the vertical business group, and each member of the vertical business group being identified by a unique referral code. The data base and server designed to retrieve a member's information stored with reference to at least one of the ad-slots in response to entering of the member's referral code and any request for information in the remaining ad-slots of the vertical business group.

### CROSS-REFERENCE TO RELATED APPLICATIONS

This application claims the benefit of U.S. Provisional Application No. 61/102,134, filed 2 Oct. 2008.

### FIELD OF THE INVENTION

This invention relates to a system and method of referrals of commissioned based and other professional service providers such as real estate and the like.

### BACKGROUND OF THE INVENTION

In various marketing industries, such as the real estate market and the like, when a real estate professional calls a customer's attention to suitable items to be purchased, competitors can easily get the customer's attention and in many instances may actually make the sale without the original real estate professional or salesman receiving any benefit. Because industries like the real estate industry require a relatively large number of professionals other than the original real estate professional, there is a large opening for other real estate professionals to work their way into a sale.

It would be highly advantageous, therefore, to remedy the foregoing and other deficiencies inherent in the prior art.

Accordingly, it is an object of the present invention to provide a new and improved system and method of advertising and marketing.

### SUMMARY OF THE INVENTION

Briefly, to achieve the desired objects of the instant invention in accordance with a preferred embodiment thereof, a referral system on a website is disclosed that includes a data base and server coupled thereto and further coupled into a publicly available website. The data base includes a plurality of industry verticals stored therein, each vertical includes a plurality of ad-slots with each ad-slot including information relative to a member of the vertical, and each member of the vertical being identified by a unique referral code. The data base and server are designed to retrieve a member's information stored with reference to at least one of the ad-slots in response to entering of the member's referral code and any request for information in the remaining ad-slots of the vertical.

The desired objects of the instant invention are further realized in a specific embodiment of a referral system on a website including a data base and server coupled thereto, the data base and server coupled into a publicly available website. The data base is designed to store information relative to a plurality of vertical business groups, each vertical business group including a plurality of ad-slots with at least one ad-slot of the plurality of ad-slots including information relative to a member of a plurality of members of the vertical business group. Marketing information of a first professional of a first vertical business group of the plurality of vertical business groups is stored with reference to a first one of the plurality of ad-slots of the first vertical business group in the data base. The server is designed to make the stored marketing information of the first professional available for retrieval by clients in response to entry of a first unique referral code. Marketing information of a second professional, referred by the first professional, of the first vertical business group is stored with reference to a second one of the plurality of ad-slots of the first vertical business group in the data base. The server is designed to make the stored marketing information of the second professional and the stored marketing information of the first professional available for retrieval by clients in response to entry of a second unique referral code.

The desired objects of the instant invention are further realized in accordance with a method of referrals and referring professionals including the step of providing a marketing system including a data base and server coupled thereto and further coupled into a publicly available website. The data base includes storage for information relative to a plurality of vertical business groups, each vertical business group including a plurality of ad-slots with each ad-slot of the plurality of ad-slots provided for information relative to each different member of the vertical business group. A first professional (e.g. a real estate agent) of one vertical business group (e.g. a real estate sales team) of the plurality of vertical business groups registers on the marketing system as a member to advertise in a first one of the plurality of ad-slots of the one vertical business group. The first professional provides marketing information for storage and retrieval in the first one of the plurality of ad-slots of the one vertical business group. The server generates a first unique referral code to the first professional, the stored marketing information of the first professional being available for retrieval by clients in response to entry of the first unique referral code. The first professional provides the first unique referral code to a second professional (e.g. a lender) of the one vertical business group. The second professional registers on the marketing system as a member and provides marketing information for storage and retrieval in a second one of the plurality of ad-slots of the one vertical business group. The server generates a second unique referral code to the second professional, the stored marketing information of the second professional and the first professional being available for retrieval by clients in response to entry of the second unique referral code.

This stored marketing information continues to stay with the client no matter where on the website the client navigates, and the advertiser will receive direct communication from the website as to key actions taken by the client for follow up correspondence or action by the advertiser/sponsor.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the drawings, in which:

FIG. 1 is a simplified block diagram of the present referral system and method in accordance with the present invention;

FIG. 2 is a representative view of information stored in the referral system of FIG. 1;

FIG. 3 illustrates an exemplary custom referral on an advertising website, in accordance with the present invention, portions therefore enlarged for accent;

FIG. 4 illustrates a specific referral procedure, i.e. a local real estate listing, on the website, in accordance with the present invention, with some features enlarged for better illustration;

FIG. 5 illustrates a specific advertisement on the website, i.e. a real estate listing in another state, in accordance with the present invention, with some features enlarged for better illustration; and

FIG. 6 is a chart illustrating a specific example of the formation of a professional team or group using the present referral system.

### DETAILED DESCRIPTION OF A PREFERRED EMBODIMENT

The present referral method can be used in a wide variety of advertising and marketing areas, such as Financial Services, Automotive, Travel and any other industry with multiple related service providers, but real estate is used as a specific example to better describe the operation in detail and so that it can be easily understood. The present referral system and method is a proactive and highly targeted method for providing a real estate purchaser (non-professional member) with an assortment of industry professionals suited to help complete a real estate transaction. Professionals that might be included are, for example, a 1031 exchange company, a self directed IRA company, brokers/agents, lenders, property managers, appraisers, inspectors, attorneys, and so forth. Two types of professionals are included here, ‘sponsors’ or a professional that appears because they referred someone directly, and ‘paid-advertisers’ or professionals that pay for empty ad-slots (defined in more detail below). In this method each of the industry “verticals” is represented as one of a plurality of advertising “ad-slots” on a website. It should be noted that this specific method can be adapted as a desktop application on a user's computer. Also, this novel method can be used in a wide variety of advertising and marketing areas but real estate is used as a specific example to better describe the operation in detail.

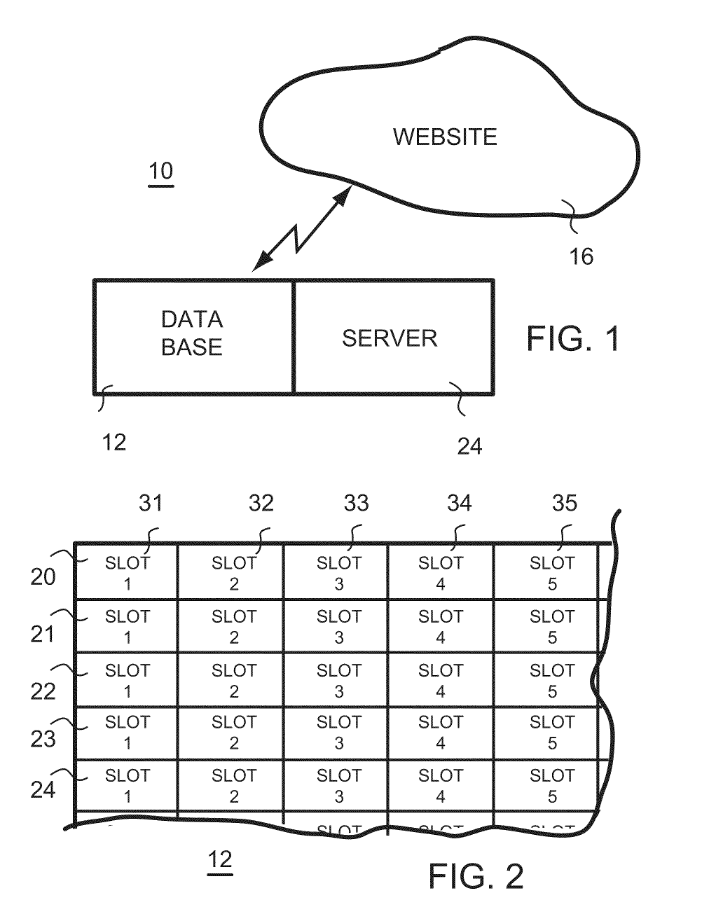

Turning to FIG. 1, an exemplary custom referral system 10 in accordance with the present invention is illustrated. Custom referral system 10 includes a data base 12 and search and retrieve apparatus, hereinafter server 14, coupled into a publicly available website 16, e.g. the World Wide Web, etc. Custom referral system 10 includes a plurality of industry verticals or Vertical Business Groups (VBG), with each “vertical business group” being defined as a group, team, or association of professionals that cooperate to complete a transaction (e.g. a sale of real estate). The VBGs are illustrated representatively in FIG. 2 and designated 20, 21, 22, 23, 24, etc., stored in data base 12, each VBG 20-24 includes a number of ad-slots, designated 31, 32, 33, 34, 35, etc. The number of ad-slots 31-35 available in each or any one VBG 20-24 can be fixed (e.g. 5 slots) or dynamic (1 to unlimited). Each ad-slot 31-35 contains stored information about one of a sponsor or an advertiser in the VBG and is identified by a unique referral code. The stored information can include, for example, various types of marketing material including the advertiser's logo, multiple (trackable) links to their website, contact information for the company (see for example the enlarged area), a link to a custom biography page within the website, a link to an email form that can auto-fill information about a property the member is viewing, a direct link to search an agent's listings, and more.

The system 10 and method of use further anticipate allowing each of the sponsors the ability to create and send out a referral code to their clients, which can be initiated by the sponsor, or automatically generated by the server. A referral code may be manually entered into system 10, for example, upon a new member signup, or automatically passed through a marketing link with the referral code embedded. An example of such a marketing link is:

http://www.investorloft.com/signup.php?R=AZBANKOWNED.).

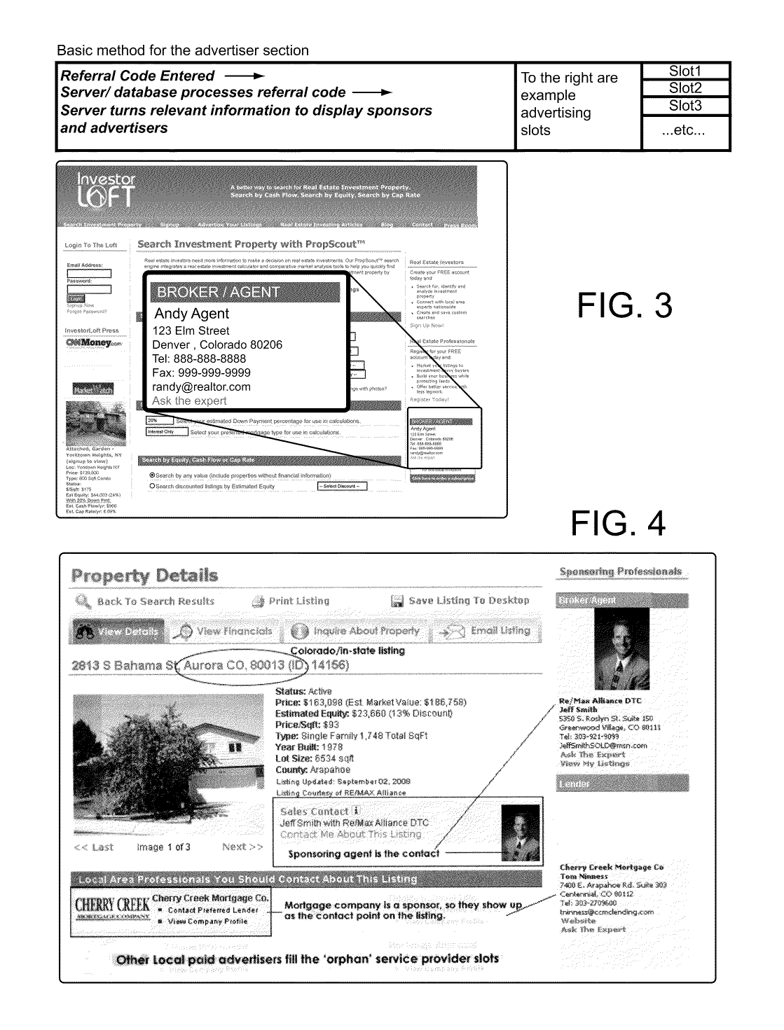

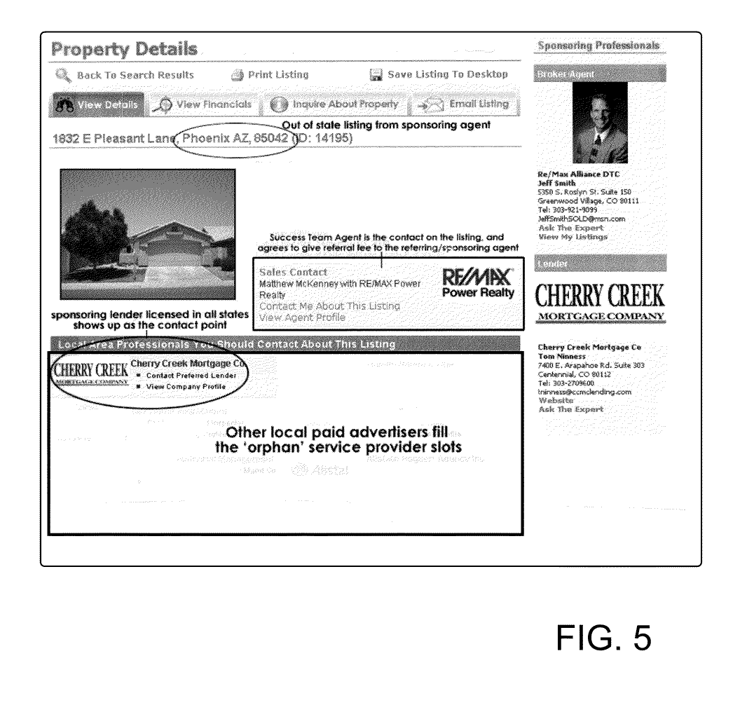

When a referral code is entered into system 10 the code connects to marketing database 12 and retrieves the referring sponsor's information in at least one of the ad-slots listed above (see FIGS. 2 and 3). Thus, when a referral code is entered, server 14 processes the referral code and returns relevant information to display sponsors and advertisers.

Sponsors and advertisers (or paid-advertisers) get their names and information into the ads-slots in a variety of ways. In a typical example, a professional, for example Broker/Agent #1, can sign up for the site and get a custom referral code that contains his information, i.e. information he supplies. When Broker/Agent #1 passes out the code to other non-professionals/clients those members will see Broker/Agent #1's contact information in various places on the site (e.g. the enlarged area of FIG. 3). If desired, system 10 can be set up to allow a group of professionals to coordinate their marketing efforts (i.e. one of verticals 20, 21, 22, 23, etc.). For example, Broker/Agent #1 refers a mortgage professional, the mortgage professional refers a title company representative, etc.

In the case where only Broker/Agent #1 is the primary referrer, the exemplary custom referral (illustrated in FIG. 3) has empty ad-slots that are generally used for listing lenders, Title 1031 exchange, etc. These empty ad-slots are referred to herein as “orphan ad-slots”, which creates an ideal vehicle for other advertisers to purchase. Advertisers will be motivated to purchase the orphan ad-slots because the orphan member is generally a targeted, qualified lead that is interested in real estate and will need a service provider in their vertical market to complete their transactions. Also, Paid-Advertisers will be motivated because they are guaranteed to be the only one in their vertical market. The system can limit the advertisers to be displayed in a number of ways, per individual listing, per geographic area (zip code, city, county, CBSA, state, etc)

Further, advertisers will be motivated because once system 10 has chosen an advertiser for each vertical 20, 21, 22, 23, etc., the system can be set to save the chosen local Paid-Advertiser, and the visitor will always see the same advertisers on every returning visit to the website. This continuity builds brand awareness and customer loyalty. By creating this highly targeted marketing space, the company employing the technology (system 10) can sell the orphan ad-slots for a significant amount of money per lead or slot.

When the client logs into the site in the future, the system looks up their permanent Sponsors. Using the example above, there is only the “Agent” permanent sponsor, and all other “vertical” ad slots are open. Next, the system looks for any Paid-Advertisers that were saved to their profile. The system then looks up ALL NON-Agent, Paid-Advertisers (ideally in the client's state). The system removes any duplicates (i.e. it found two 1031 companies—will only show one of them). Now the system is ready to display all advertisers in their various locations, based on the content of the page (i.e. Property listing page, resource center page, blog, or other).

In the case where a top-level referrer, such as a 1031 exchange company, refers a non-professional directly, the 1031 exchange company fills the 1031 exchange sponsor ad-slot and the remaining ad-slots become orphan ad-slots. This part of referral system 10 allows the orphan ad-slots to be controlled and filled by other advertisers in each of the industry verticals 20, 21, 22, 23, etc. In this example, system 10 chooses an appropriate advertiser for each slot of a vertical based on a number of factors, including but not limited to the member's location and preferences notated on the sign-up form, among other things. The top-level referral codes can also be sent to other vertical market associates (i.e. other systems), to expand their referral reach. For example, a 1031 exchange company can give their referral code to all of the Broker/Agents in their database. When a Broker/Agent registers using the 1031 exchange company's code, system 10 generates a new unique code which the Broker/Agent can pass out to their clients. New members who signup with the Broker/Agent's referral code will see the referring 1031 exchange company and the referring Broker/Agent, along with any orphan ad-slot advertisers.

This process or method solves a deficiency in the marketplace in many ways.

First, this system insures that there are never any competitive advertisers in the vertical industry on each web page. Additionally, each chosen vertical advertiser can add their industry specific content to the resource center or blog without overloading a client where there are many articles on the same subject by competitive companies.

Second, service providers that are normally limited to a local market can track their client activity and enforce fees or commissions for out-of-area transactions, and greatly expand their offerings to a nationwide or worldwide reach.

Third, every member is paired with local, qualified professionals based on their location, or the location of the target listing to provide optimal service to clients.

Fourth, members are shown the same Sponsored advertising for life, which helps to build rapport and confidence with the referring sponsor(s).

Fifth, members can be shown the same Paid-Advertiser (orphan) ads for the duration of the paid-ad contract, which also helps to build rapport for the Paid-Advertiser instead of a per impression/rotating ad method which is ineffective, causes confusion for the consumer, and reduces brand awareness.

Referring to the method in more detail (and again using real estate as the example), when a sponsor's referral code comes to the website, the sponsor will automatically be the contact point for any listings in his licensed market. This can be adjusted to show the referring sponsor as the contact for all listings on the site, only listings from the sponsor's state, only listings from the sponsor's MLS Board(s) they subscribe to, or even limited to the sponsor's city or county.

For this example, if Broker/Agent #1 is an agent in Colorado, and his client is viewing a listing in Colorado, Broker/Agent #1 will show up as the only contact point on that listing. Referring to FIG. 4, this example is illustrated as a local real estate listing on the website.

If Broker/Agent #1's referral is viewing a listing in another state, as illustrated in FIG. 4, Broker/Agent #1 likely is not licensed to transact the sale of real estate in the other state. Thus, the system chooses a pre-approved, Paid-Advertiser Broker/Agent of the website who is licensed in that market or state. Furthermore, the system is programmed so that it knows that Broker/Agent #1 originally referred the client, so if the client requests more information on the listing, a notification is sent by mail, email, phone call or SMS text message to the Paid-Advertiser Broker/Agent and to Broker/Agent #1, so Broker/Agent #1 can collect a referral fee from the Paid-Advertiser Broker/Agent. A copy of the lead notification is saved in both Broker/Agent #1's account, and also in the Paid-Advertiser Broker/Agent's account for reference, and can also be copied to an external CMS/lead management system for either Broker/Agent.

Thus, system 10 receives Broker/Agent #1's referral code; the member views a listing in Colorado; system 10 shows Broker/Agent #1 as the contact point. System 10 receives Broker/Agent #1's referral code; the client views a listing in another state; system 10 shows a Paid-Advertiser Broker/Agent but keeps Broker/Agent #1 in the loop for any listing inquiries.

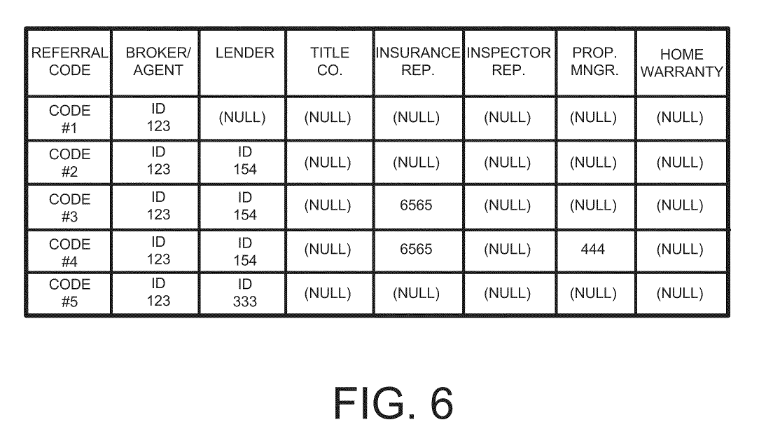

To illustrate the operation described above in a specific situation attention is directed to FIG. 6. As described in conjunction with FIG. 2, horizontal rows represent VBGs while vertical columns represent specific professionals in the real estate industry (in this specific example). The first column (starting at the left) includes referral codes, the second column represents Broker/Agents, the third column represents lenders, the fourth column represents title companies, the fifth column represents insurance representatives, the sixth column represents inspectors, the seventh column represents property managers, the eighth column represents home warranty companies, etc.

Code #1 is a referral code assigned to a Broker/Agent whose ad information is stored under ID123. In this example, Broker/Agent ID123 has signed up and received referral code #1. All of the other ad-slots, designated (null), are empty and can be filled with Paid-Advertisers. If Broker/Agent ID123 refers a lender (ID154) to the system and lender ID154 uses referral code #1 of Broker/Agent ID123 they work as a team. Lender ID154 receives the referral code #2. Anyone who signs up with the referral code #2 (referred by Lender) will always see lender ID154 and the referring Broker/Agent ID123 because Lender was referred and used code #1. If Lender ID154 refers an insurance representative (6565) to the system and insurance representative 6565 uses referral code #2 of Lender ID154 they work as a team. Insurance representative 6565 receives the referral code #3. Anyone who signs up with the referral code #3 (referred by Insurance Rep.) will always see insurance representative 6565, lender ID154 and the referring Broker/Agent ID123. If Insurance Rep. 6565 refers a property manager (444) to the system and property manager 444 uses the referral code of Insurance Rep. 6565 they work as a team. Property manager 444 receives the referral code #4. Anyone who signs up with the referral code #4 will always see property manager 444, insurance representative 6565, lender ID154 and the referring Broker/Agent ID123.

In the above example, a chain of depending referral numbers is formed. In another example, if Broker/Agent ID123, using referral code #1, or a new, different code, refers a different lender (ID333) to the system and lender ID333 uses referral code #1 (or the different code) of Broker/Agent ID123 they work as a different team. Lender ID133 receives the referral code #5. Anyone who signs up with the referral code #5 will always see lender ID333 and the referring Broker/Agent ID123.

Thus, the present system and method of advertising and marketing, controls web referrals and advertising for marketing platforms and vertical search engines based on the referral source, while controlling regulation, competition, and keeping the referrer in control of their own transactions. For regulated industries (e.g. real estate), the present system and method of advertising and marketing allows the members of that industry to participate in a website that has other related/competitive businesses advertising on that site, without violating the co-marketing restrictions of their various regulating parties. In essence, a real estate professional for example, can refer a potential client to the website, where the system can connect them to a 1031 exchange company or self directed IRA provider, without worrying that they are liable for the performance of those professional service providers, or that they are violating RESPA by co-marketing with a title company, lender, or Broker/Agent. This is true because it's the system or engine that is placing the ads for the other related industries, not the real estate professionals themselves.

Where applicable, the referring service provider (i.e. Broker/Agent) is notified upon their client's request for other vertical services (i.e. Lending or 1031 Exchange services) from co-sponsors or Paid-Advertisers. Meanwhile, the co-sponsor or Paid-Advertiser is notified of the originating referrer along with the request for services.

This allows the originating referrer to track what their referrals are doing and collect additional fees or commissions across different verticals, which provides significant value to all referring professionals of the site, as well as the paid-advertisers.

To the owner of the website (FIG. 1), this system provides the opportunity for exponential traffic growth through the inherent social networking and viral nature of the system.

One issue that arises in the real estate business is that when a real estate professional sends a client to a standard database, the real estate professional cannot co-market the client with a title company because of the RESPA restrictions and the real estate professional is restricted to refer other industry professionals because of the regulations around co-marketing. The present system and method of advertising and marketing, controls the content that is shown to referrals from regulated sources, that is the present system and method of advertising and marketing individualizes the content that is shown on the website, based on that referral source. For example, a 1031 exchange company refers a real estate professional to the website, now the resource center and eventually the featured properties can be built around the 1031 exchange company and their subsequent referrals. The system is programmed to show the articles from the referring resource and hide the articles from the other publishers/sponsors, to eliminate additional competitive content. The system is also programmed to select the featured properties from the referring Broker/Agent (if any) and not to fill another Broker/Agent ad-slot, because the Broker/Agent slot is filled.

Referring to the method in more detail (and again using real estate as the example), the master website can be adapted to license or co-brand the offerings of the website to another company. Effectively all functions of the website are the same except the main URL and overall design or branding of the site. One notable improvement is the ability for the licensee to sell their own set of Paid-Advertisers and split the ad revenue with the licensing company.

An additional benefit is that the Licensor and Licensee can overlap the Paid-Advertisers, thereby giving the Paid-Advertisers increased exposure. For example, the Licensee does not have a Paid-Advertiser in Denver Colo.—so the system will select the Paid-Advertiser from the Licensor's database of Paid-Advertisers.

### Example #1

An Agent from Denver, Co. signs up and the system generates his referral code AGENT1.

The Agent refers his client (via email or his website), the client signs up with the AGENT1 code.

The client is now permanently assigned to that Agent, and the Agent will be the contact point on EVERY listing in that Agent's area, and the Agent's photo and contact info is displayed prominently on almost every page of the website.

If the client is viewing a listing out of the Agent's state (i.e. Florida) one of the Paid-Advertisers (who is local to that area) becomes the contact point on the listing, since the referring Agent most likely doesn't know about that market, and usually does not have access to the Florida MLS to do more research.
For sponsors (e.g. agents) that are limited to local areas, each Paid-Advertiser must agree to pay a referral fee to the original referring Agent.
The benefit is the Agent can essentially provide a nationwide (or worldwide) search engine to his/her client, and still collect a commission for the lead when it is outside of their local market.

In the meantime:
General info pages on the site will show various non-competing advertisers (like 1031 Exchange services, or Self Directed IRA Services). Usually these types of advertisers can perform their services on a non-local scale—or the system can select them based on where the Client lives.
All listing pages will look for local, specialized service providers to display in and around the listing information (i.e. local lender, local title company, local inspector, etc.).

Briefly, as an example of how Sponsors and Paid-Advertisers are selected:
When the client logs into the site in the future, the system looks up their permanent Sponsors;
Using the example above, there is only the “Agent” permanent sponsor, and all other “vertical” ad slots are free;
Next the system looks for any Paid-Advertisers that were saved to their profile;
Then the system looks up ALL NON-Agent, Paid-Advertisers (ideally in the client's state);
The system removes any duplicates (i.e. the system found two 1031 companies—only show one of them); and
Now the system is ready to display all advertisers in their various locations, based on the content of the page (e.g. Property listing page, resource center page, blog, or other).

Various changes and modifications to the embodiments herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. A professional referral system on a website comprising:
a data base and server coupled thereto, the data base and server coupled into a publicly available website;
the data base including information relative to a plurality of vertical business groups stored therein, each vertical business group including a plurality of ad-slots with at least one ad-slot of the plurality of ad-slots including information relative to a member of a plurality of members of the vertical business group, and each member of the plurality of members of the vertical business group being identified by a unique referral code; and
the data base and server designed to retrieve a member's information stored with reference to at least one of the ad-slots in response to entering of the member's referral code and any request for information in the remaining ad-slots of the vertical business group.

2. A professional referral system as claimed in claim 1 wherein each of the plurality of ad-slots in each vertical business group of the plurality of vertical business groups includes information relative to one of a sponsor and an advertiser.

3. A professional referral system as claimed in claim 1 wherein each vertical business group of the plurality of vertical business groups is associated with one of commissioned-based or compliance regulated professional service providers.

4. A professional referral system as claimed in claim 3 wherein at least some of the ad-slots in at least some of the vertical business groups include an assortment of industry professionals suited to help complete a real estate transaction.

5. A professional referral system as claimed in claim 4 wherein the assortment of industry professionals include at least one of a 1031 exchange company, a self directed IRA company, Broker/Agents, lenders, property managers, appraisers, inspectors, and attorneys.

6. A professional referral system as claimed in claim 1 wherein the data base and server are designed to retrieve a first member's information stored with reference to a first one of the ad-slots in response to entering of the first member's referral code and to further retrieve information stored with reference to other of the ad-slots pertaining to any other members that referred the first member to the system.

7. A professional referral system on a website comprising:
a data base and server coupled thereto, the data base and server coupled into a publicly available website;
the data base being designed to store information relative to a plurality of vertical business groups, each vertical business group including a plurality of ad-slots with at least one ad-slot of the plurality of ad-slots including information relative to a member of a plurality of members of the vertical business group; and
marketing information of a first professional of a first vertical business group of the plurality of vertical business groups stored with reference to a first one of the plurality of ad-slots of the first vertical business group in the data base, the server being designed to make the stored marketing information of the first professional available for retrieval by clients in response to entry of a first unique referral code; and
marketing information of a second professional, referred by the first professional, of the first vertical business group stored with reference to a second one of the plurality of ad-slots of the first vertical business group in the data base, the server being designed to make the stored marketing information of the second professional and the stored marketing information of the first professional available for retrieval by clients in response to entry of a second unique referral code.

8. A professional referral system as claimed in claim 7 further including marketing information of a third professional, referred by the second professional, of the first vertical business group stored with reference to a third one of the plurality of ad-slots of the first vertical business group in the data base, the server being designed to make the stored marketing information of the third professional, the stored marketing information of the second professional and the stored marketing information of the first professional available for retrieval by clients in response to entry of a third unique referral code.

9. A method of referring professionals comprising the steps of:
providing a marketing system including a data base and server coupled thereto and further coupled into a publicly available website, the data base including information relative to a plurality of vertical business groups stored therein, each vertical business group including a plurality of ad-slots with at least one ad-slot of the plurality of ad-slots including information relative to a member of the vertical business group, and each member of the vertical business group being identified by a unique referral code, and the data base and server designed to retrieve a member's information stored with reference to at least one of the ad-slots in response to entering of the member's referral code and any request for information in the remaining ad-slots of the vertical business group;
a sponsor registering on the marketing system as a member to advertise in one of the plurality of ad-slots of one of the plurality of vertical business groups, the sponsor providing marketing information for storage and retrieval in the one of the plurality of ad-slots;
the server generating a unique referral code to the sponsor;
the sponsor distributing the unique referral code to clients; and
the stored marketing information available for retrieval by the clients in response to entry of the unique referral code.

10. A method as claimed in claim 9 wherein the sponsor is a real estate agent.

11. A method as claimed in claim 10 wherein the remaining ad-slots of the plurality of ad-slots of the one of the plurality of vertical business groups include information of at least one of a 1031 exchange company, a self directed IRA company, a Broker/Agent, lenders, property managers, appraisers, inspectors, and attorneys.

12. A method as claimed in claim 9 wherein the one of the plurality of vertical business groups includes a plurality of different professionals, each different professional performing a different function for the one of the plurality of vertical business groups, and the sponsor being a first professional of the plurality of different professionals, the method including the additional steps of:
the sponsor providing the sponsor's unique referral code to a second professional of the plurality of different professionals;
the second professional registering on the marketing system as a member and providing marketing information for storage and retrieval in a second one of the plurality of ad-slots;
the server generating a second unique referral code to the second professional;
the second professional distributing the second unique referral code to clients; and
the stored marketing information of the second professional and the sponsor being available for retrieval by the clients in response to entry of the second unique referral code.

13. A method as claimed in claim 12 including the additional steps of:
the second professional providing the second unique referral code to a third professional of the plurality of different professionals;
the third professional registering on the marketing system as a member and providing marketing information for storage and retrieval in a third one of the plurality of ad-slots;
the server generating a third unique referral code to the third professional;
the third professional distributing the third unique referral code to clients; and
the stored marketing information of the third professional, the second professional and the sponsor being available for retrieval by the clients in response to entry of the third unique referral code.

14. A method of referring professionals comprising the steps of:
providing a marketing system including a data base and server coupled thereto and further coupled into a publicly available website, the data base including storage for information relative to a plurality of vertical business groups, each vertical business group including a plurality of ad-slots with each ad-slot of the plurality of ad-slots provided for information relative to each different member of the vertical business group;
a first professional of one vertical business group of the plurality of vertical business groups registering on the marketing system as a member to advertise in a first one of the plurality of ad-slots of the one vertical business group, the first professional providing marketing information for storage and retrieval in the first one of the plurality of ad-slots of the one vertical business group;
the server generating a first unique referral code to the first professional, the stored marketing information of the first professional being available for retrieval by clients in response to entry of the first unique referral code;
the first professional providing the first unique referral code to a second professional of the one vertical business group;
the second professional registering on the marketing system as a member and providing marketing information for storage and retrieval in a second one of the plurality of ad-slots of the one vertical business group; and
the server generating a second unique referral code to the second professional, the stored marketing information of the second professional and the first professional being available for retrieval by clients in response to entry of the second unique referral code.

15. A method as claimed in claim 14 wherein the first professional and the second professional are each a different member of a vertical business group including one of Financial Services, Automotive, and Travel.

16. A method of marketing as claimed in claim 14 and further including the steps of:
the second professional providing the second unique referral code to a third professional of the one vertical business group;
the third professional registering on the marketing system as a member and providing marketing information for storage and retrieval in a third one of the plurality of ad-slots of the one vertical business group; and
the server generating a third unique referral code to the third professional, the stored marketing information of the third professional, the second professional and the first professional being available for retrieval by clients in response to entry of the third unique referral code.

17. A method as claimed in claim 16 wherein the first professional, the second professional and the third professional are each a different member of a vertical business group including at least three of a 1031 exchange company, a self directed IRA company, a Broker/Agent, lenders, property managers, appraisers, inspectors, and attorneys.

18. A method as claimed in claim 16 wherein the first professional, the second professional and the third professional are each a different member of a vertical business group including one of Financial Services, Automotive, and Travel.
